(19) United States
(12) Patent Application Publication
(10) Pub. No.: US 2026/0134094 A1
(43) Pub. Date: May 14, 2026

(54) SYSTEM AND METHODS FOR AI-DRIVEN DATA BREACH RESOLUTION

(71) Applicant: BANK OF AMERICA CORPORATION, CHARLOTTE, NC (US)

(72) Inventors: Kirk A. Hawrysio, Oak Point, TX (US); Malinda Mae Kieffer, Chillicothe, MO (US); Owen Nelson, Farmingdale, NY (US); Pankaj Nagpal, CHARLOTTE, NC (US); Noel Arnaldo Medina, Katy, TX (US); Anne Matrone, Staten Island, NY (US); Robert R. Rosseland, Huntersville, NC (US); Naveen Adala, Charlotte, NC (US); Kevin A. Delson, Woodland Hills, CA (US); Thomas David Morris, Middleburg, FL (US); Tanya A. Wilson, Newark, DE (US); John David Weber, Lake St. Louis, MO (US)

(73) Assignee: BANK OF AMERICA CORPORATION, CHARLOTTE, NC (US)

(21) Appl. No.: 18/945,763

(22) Filed: Nov. 13, 2024

(51) Int. Cl. G06F 21/55

(52) U.S. Cl. CPC G06F 21/554; G06F 2221/034

(57) ABSTRACT

Systems, computer program products, and methods are described herein for AI-driven data breach resolution. The present disclosure is configured to detect data breaches in real-time and initiate an automated response to secure affected accounts. Upon detection, the system freezes compromised accounts, notifies clients and vendors, and assigns new account numbers to maintain continuity. An AI-driven chatbot assists clients in updating account information, redirecting autopayments, and resetting passwords. The system further enables clients to review recent transactions on compromised accounts, approving or denying each to prevent malfeasance. Once the client's account information is updated and transactions are adjudicated, the system restores account functionality with enhanced security settings. This automated, multi-step approach minimizes client disruption, streamlines breach response, and enhances account security by leveraging artificial intelligence, machine learning, and automated workflows to provide a comprehensive data breach resolution process.

### TECHNOLOGICAL FIELD

Example embodiments of the present disclosure relate to AI-driven data breach resolution.

### BACKGROUND

Data breaches pose significant issues for clients, vendors, and financial institutions, often resulting in financial loss, reputational damage, and client mistrust. Current methods for addressing data breaches are frequently time-consuming and complex, involving delayed notifications, manual intervention, and intricate processes that clients find confusing and difficult to navigate. Additionally, without immediate action to freeze and secure compromised accounts, clients and vendors face increased chance of further malfeasant transactions and exposure to financial losses.

Applicant has identified a number of deficiencies and problems associated with AI-driven data breach resolution. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for AI-driven data breach resolution. The disclosed technology facilitates the immediate resolution of data breaches, minimizing client disruption and potential losses. Upon detecting a breach, the system automatically freezes affected accounts, notifies vendors, assigns new account numbers, and informs clients through various communication channels. An AI chatbot assists clients in transitioning to new accounts, updating payment information, and securing account settings. Further, the system provides clients with a transaction review option, allowing them to approve or deny recent transactions on compromised accounts, streamlining adjudication and ensuring client security with minimal delay.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for AI-driven data breach resolution, in accordance with an embodiment of the disclosure;

FIG. 2 illustrates an exemplary generative AI subsystem 200, in accordance with an embodiment of the invention; and

FIG. 3 illustrates a process flow for AI-driven data breach resolution, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

As used herein, “data breach” may refer to an unauthorized access event where sensitive information, such as account details, payment information, or personal identifiers, is accessed, exposed, or compromised. A data breach may involve malicious hacking, unauthorized access, or inadvertent exposure of protected data.

As used herein, “freezing an account” may refer to a temporary suspension of all transaction capabilities associated with an account to prevent any unauthorized use or movement of funds. Account freezing can include halting transactions, limiting access, and disabling associated payment instruments until reactivation.

As used herein, “vendor notification” may refer to an automated alert or message sent to vendors or merchants whose transactions with a client are affected by a data breach. This notification informs vendors of the account freeze and may specify actions to take or conditions required before further transaction processing.

As used herein, “new account assignment” may refer to the automated generation and allocation of a new account number to a client whose existing account has been compromised. The new account assignment may include redirecting existing transactions, updating linked payment methods, and reconfiguring access credentials.

As used herein, “client notification” may refer to an alert or message sent to the client whose account is compromised, providing information about the data breach, actions being taken, and guidance for next steps. Notifications may be sent via multiple communication channels, such as phone, text, email, or in-app messaging.

As used herein, “AI chatbot” may refer to an artificial intelligence-based conversational agent designed to assist clients with data breach recovery steps. The AI chatbot may handle requests related to updating payment information, redirecting autopay transactions, requesting new payment instruments, and offering general support during the account recovery process.

As used herein, “transaction adjudication” may refer to the process by which a client reviews and either approves or denies pending transactions on a compromised account. Adjudication ensures that authorized transactions proceed while blocking suspicious or malfeasant transactions.

As used herein, “approve/deny button” may refer to an interface component allowing clients to manually confirm or reject transactions on their compromised account, facilitating transaction adjudication and reducing the chance of processing unauthorized transactions.

As used herein, “account recovery” may refer to the set of actions and processes undertaken by the system to restore account access and functionality following a data breach. This may include assigning a new account number, updating security settings, and providing guidance for transitioning recurring transactions and payment authorizations.

As used herein, “security settings update” may refer to modifications applied to an account to enhance protection following a data breach. This may include password changes, multi-factor authentication adjustments, and additional restrictions on account access.

As used herein, “issue monitoring” may refer to automated tools and procedures that continuously assess transactions and account activity to detect and respond to potential malfeasant activity.

As used herein, “autopay redirect” may refer to the process by which scheduled or recurring payment instructions are transferred from a compromised account to a newly assigned account, ensuring continuity of payments without exposing the new account to prior vulnerabilities.

As used herein, “client support system” may refer to the suite of tools, including AI-driven chatbots and virtual assistants, designed to aid clients through the data breach resolution and account recovery process. The client support system may provide instructions, answer questions, and facilitate the transition to new account credentials.

As used herein, “virtual assistant” may refer to a digital agent embedded within the system that provides interactive support to clients, helping with tasks such as setting up new accounts, requesting replacement payment instruments, and updating account credentials.

As used herein, “notification channel” may refer to any medium or method used to communicate with clients and vendors regarding the data breach. Examples include SMS, email, phone calls, in-app notifications, and push notifications.

As used herein, “Artificial Intelligence” or “AI” refers to computational systems and methods capable of performing tasks that typically require human intelligence. AI encompasses a range of technologies, including but not limited to, algorithms, models, and systems designed to perceive their environment, process information, and respond adaptively. AI systems may include rule-based models, knowledge-based systems, and data-driven models. AI may utilize structured data, unstructured data, or real-time inputs to perform various actions such as making decisions, recognizing patterns, understanding natural language, visual perception, learning, and executing complex problem-solving tasks.

In some embodiments, AI involves automated reasoning and decision-making capabilities based on predetermined rules, patterns, and/or probabilistic inferences derived from data. Such reasoning may be employed to execute tasks, interpret data inputs, generate predictions, and optimize solutions with minimal human intervention. For the purposes of the present disclosure, AI may interact with users or systems through natural language processing, virtual agents, recommendation engines, and other interactive applications that support the detection, analysis, and resolution of data breaches.

AI may also comprise deep learning and neural networks, which are subfields that rely on layered architectures inspired by biological neural systems. These architectures allow AI models to learn abstract representations and perform complex functions, such as anomaly detection and predictive analytics, that are valuable for real-time breach detection and client support functions in the disclosed invention.

As used herein, “Machine Learning” or “ML” refers to a subset of AI that involves algorithms and models enabling systems to automatically learn from data and improve performance on specific tasks over time without explicit programming for each iteration. Machine Learning encompasses supervised learning, unsupervised learning, semi-supervised learning, and reinforcement learning, among other methodologies. These methodologies allow ML models to identify patterns, make decisions, or provide predictions based on data inputs.

Machine Learning algorithms may be trained on historical data to identify patterns of normal and abnormal account activity, thereby facilitating anomaly detection, issue prevention, and prediction of future security breaches. In certain embodiments, supervised learning may involve labeled datasets to enable the model to associate input features with specific outcomes, such as distinguishing malfeasant transactions from legitimate ones. Unsupervised learning may be used to detect unknown patterns or groupings in data without labeled outcomes, which can assist in identifying suspicious account behavior in real-time.

For the purposes of the present disclosure, ML may also involve deep learning, wherein algorithms based on artificial neural networks with multiple layers (deep neural networks) are trained to perform more complex tasks such as image recognition, natural language processing, and real-time client interaction. Reinforcement learning may further be employed, wherein models learn optimal actions by receiving feedback based on outcomes, improving breach resolution processes through iterative learning. ML-based models may continuously adapt to evolving patterns in breach data, thereby enhancing the system's effectiveness and responsiveness to new types of data security threats.

The technology presented in this disclosure is a comprehensive, AI-driven data breach resolution system designed to immediately mitigate the impact of a data breach by automating crucial actions such as freezing accounts, notifying affected parties, reassigning account numbers, and guiding clients through the recovery process. This system combines artificial intelligence, mobile interfaces, chatbots, and online banking applications to create a seamless, end-to-end solution for data breach response.

Data breaches represent a persistent and escalating problem within the financial and data security fields. In current practices, clients often face delayed notifications, complex account recovery processes, and inadequate support following a breach, which can lead to prolonged vulnerability, client frustration, and reputational damage. Additionally, vendors and servicers are vulnerable to further malfeasant transactions when data breach responses are not immediate and efficient.

In layperson's terms, this invention offers a system that acts immediately upon detecting a data breach to secure clients'accounts and provide them with guided support to restore account access and update payment information quickly. This system also allows clients to review recent transactions on their compromised accounts, confirming legitimate resource transfers while blocking malfeasant ones. An AI-driven chatbot assists clients in re-establishing their account credentials and payment methods, simplifying what would otherwise be a long, stressful process into a quick, user-friendly experience.

Accordingly, the present disclosure provides a system for immediate data breach response that can (i) automatically freeze compromised accounts and notify both the client and relevant vendors, (ii) reassign account numbers to affected clients and offer direct support in setting up new payment credentials, (iii) allow clients to review recent transactions for approval or denial, and (iv) leverage artificial intelligence through chatbots to guide clients through security tasks such as password changes, autopay updates, and monitoring. The system thus minimizes client disruption and streamlines the overall data breach recovery process, providing enhanced security and convenience.

What is more, the present disclosure provides a technical solution to a technical problem. As described herein, the technical problem includes delayed, inefficient, and complex responses to data breaches that leave clients and vendors vulnerable to additional malfeasant transactions and financial issues. The technical solution presented herein allows for an automated, AI-driven response that immediately secures accounts, notifies affected parties, and supports clients in updating their account information. In particular, the AI-driven data breach resolution system is an improvement over existing solutions to data breach management, (i) with fewer steps to achieve the solution, thus reducing the amount of computing resources, such as processing, storage, and network resources, that are being used, (ii) providing a more accurate and streamlined approach to account recovery, thus minimizing errors and reducing resources needed for remediation, (iii) removing the need for manual input and redundant steps, thus improving the speed and efficiency of the process, and (iv) optimizing resource allocation to handle data breach events, thereby reducing network traffic and load on existing computing resources. Furthermore, the technical solution described herein utilizes a rigorous, computerized process to perform specific breach response tasks that were previously unautomated, conserving computing resources and accelerating resolution.

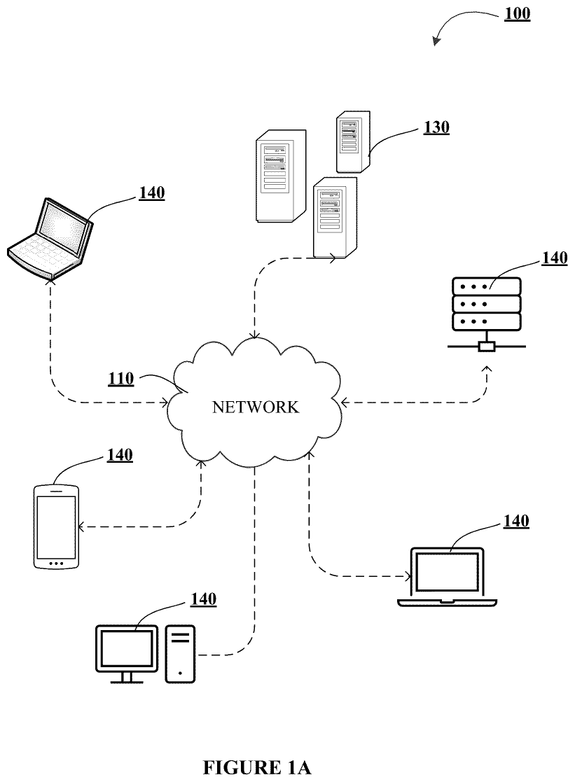

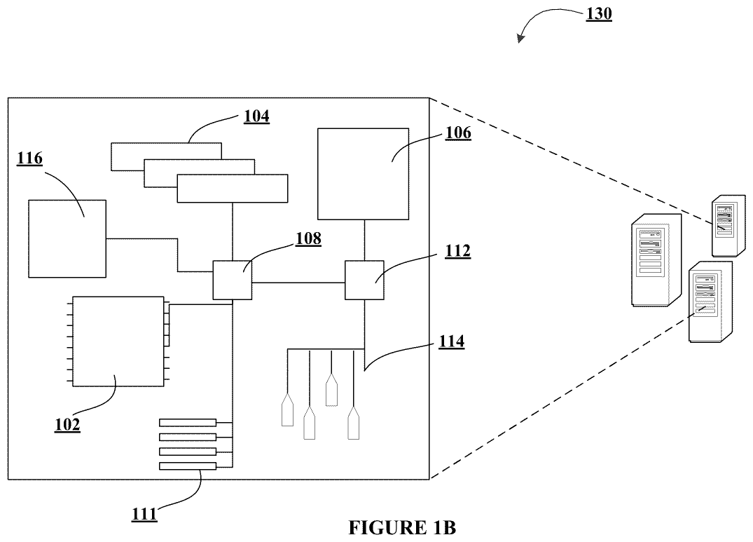

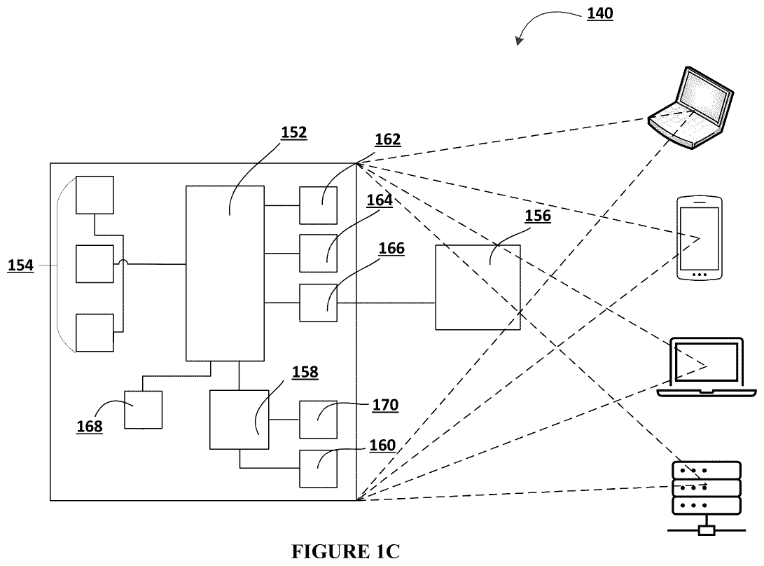

FIGS. 1A-1C illustrate technical components of an exemplary distributed computing environment for AI-driven data breach resolution 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

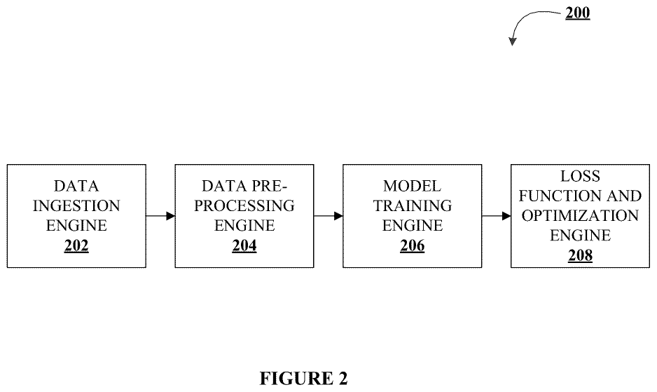

FIG. 2 illustrates an exemplary generative AI subsystem 200, in accordance with an embodiment of the invention. The generative AI subsystem 200 may include a data ingestion engine 202, a data pre-processing engine 204, a model training engine 206, and a loss function and optimization engine 208. It should be understood that the generative AI subsystem 200 is merely an example, and other embodiments may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 200 should not be considered limiting and may be adapted to various configurations within the scope of the invention.

The data ingestion engine 202 may identify various internal and/or external data sources to generate, test, and/or integrate new features for training the generative AI model. These internal and/or external data sources may be initial locations where the data originates or where physical information is first digitized. In addition to conventional data sources, the data ingestion engine 202 may support decentralized storage systems, such as blockchain-based data sources, and privacy-preserving methods such as differential privacy. The data ingestion engine 202 may identify the location of the data and describe connection characteristics for access and retrieval of data. In some embodiments, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like.

Depending on the nature of the data, the data ingestion engine 202 may move the data to a destination for storage or further analysis. Typically, the data may be in varying formats as they come from different sources, including RDBMS, other types of databases, S3 buckets, CSVs, or from streams. Since the data comes from different places, it needs to be cleansed and transformed so that it can be analyzed together with data from other sources. The data may be ingested in real-time, using stream processing, in batches using a batch data warehouse, or a combination of both. Stream processing may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse collects and transfers data in batches according to scheduled intervals, trigger events, or any other logical ordering.

In machine learning, the quality of data and the useful information that can be derived therefrom directly affects the ability of the machine learning model to learn. The data pre-processing engine 204 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed. In some embodiments, the data pre-processing engine 204 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 204 may transform categorical data into numerical formats that are suitable for machine learning algorithms. In this regard, the data pre-processing engine 204 may use techniques such as one-hot encoding or label encoding depending on the nature of the categorical variables and the intended use of the data.

In some embodiments, the data pre-processing engine 204 may also include dimensionality reduction techniques, where the number of input features is reduced while retaining the most relevant information. In this regard, the data pre-processing engine 204 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 204 may then be fed into the model training module 206.

The model training engine 206 may be responsible for training the generative AI models using the pre-processed data from the data pre-processing engine 204. The model training engine 206 may implement various machine learning algorithms, including but not limited to Generative Adversarial Networks (GANs), Variational Autoencoders (VAEs), or other generative models, depending on the specific requirements of the system. The model training engine 206 may optimize these models by continuously adjusting their internal parameters based on the patterns and relationships identified within the data.

In some embodiments, the model training engine 206 may include a training data handler, which manages the partitioning of the pre-processed data into training, validation, and testing datasets. The training data is used to update the model's parameters, while the validation and testing datasets are reserved to evaluate the model's performance during and after training. The model training engine 206 may support various data-handling strategies, such as cross-validation or random shuffling, to ensure that the model generalizes well and is not overfitting to the training data.

For VAEs, the model training engine 206 may implement an encoder-decoder architecture. In this architecture, the encoder is responsible for compressing or mapping the input data into a lower-dimensional latent space representation, capturing the essential features of the input data while discarding unnecessary details. The decoder, in turn, reconstructs the input data from this latent representation, aiming to recreate the original data as closely as possible. During training, the VAE model seeks to minimize a loss function that typically consists of two components: reconstruction loss and Kullback-Leibler (KL) divergence loss.

The reconstruction loss ensures that the difference between the original input and the reconstructed output is minimized, guiding the decoder to generate outputs that closely resemble the input data. The second component, KL divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In embodiments using GANs, the model training engine 206 may train two distinct but interconnected networks: the generator and the determinator. The generator network is responsible for generating synthetic data samples, typically starting from random noise vectors or points sampled from a latent space. The generator's objective is to learn how to map this random input into realistic data that closely resembles the actual data distribution from the training set, such as images, financial plans, or any other domain-specific data. On the other side, the determinator network is tasked with differentiating between the real data—coming directly from the training set—and the synthetic data generated by the generator. The determinator acts as a binary classifier, aiming to correctly classify whether the input data is real or fake. Its job is to improve its accuracy over time in detecting whether the data it is evaluating comes from the true data distribution or has been synthetically created by the generator.

The training process of a GAN is adversarial in nature, where the two networks engage in a zero-sum model. The generator continuously tries to improve its ability to generate convincing data, while the determinator simultaneously improves its capacity to distinguish between real and generated data. During each training iteration, the generator attempts to “fool” the determinator by creating more realistic data samples, while the determinator receives feedback to better catch fake data. This adversarial feedback loop leads both networks to improve their performance over time. The loss functions for both networks guide this competition: the generator's loss reflects how well it was able to fool the determinator, while the determinator's loss reflects how accurately it classified real versus generated data. Through this iterative, competitive process, the generator becomes increasingly skilled at producing highly realistic data samples that are difficult for the determinator to differentiate from real data. Eventually, the generator learns to generate synthetic data that is nearly indistinguishable from the real data.

The model training engine 206 may include a parameter optimization module, which may optimize the model's parameters using gradient-based optimization techniques such as stochastic gradient descent (SGD), Adam, or other suitable algorithms. The optimization process may minimize the loss function calculated during each training iteration (or epoch), adjusting the weights and biases of the model to improve its ability to learn from the data. The parameter optimization module may also dynamically adjust learning rates, momentum, and other hyperparameters to further enhance training efficiency.

In some embodiments, the model training engine 206 may implement early stopping mechanisms to prevent overfitting. Early stopping monitors the generative AI model's performance on the validation dataset, halting the training process if the performance does not improve after a specified number of iterations. This ensures that the generative AI model does not continue training on noise or irrelevant patterns, which could degrade its performance on unseen data. The model training engine 206 may also support distributed training across multiple computing nodes, allowing the system to scale its computational resources as needed. Distributed training may involve splitting the generative AI model and data across multiple machines or GPUs, where each node processes a portion of the data and updates the model in parallel. This is particularly useful for large datasets or models that require significant computational power, such as deep generative models. The model training engine 206 may synchronize the updates across the nodes using techniques like synchronous or asynchronous gradient descent.

Once the generative AI model is trained, the model training engine 206 may save the final trained generative AI model in a persistent storage location for future use. In specific embodiments, metadata such as the number of epochs, the final loss values, and values of learned parameters may be logged for model versioning and/or retraining at a later stage. In some embodiments, the model training engine 206 may also implement transfer learning, where a pre-trained model is fine-tuned on a smaller, domain-specific dataset. This may reduce the amount of time and data required to train a new model, especially in cases where the available data is limited or highly specialized. The model training engine 206 may adjust the parameters of the pre-trained model to better align with the new dataset, while preserving the learned features from the original training.

In embodiments where a VAE is used to train the generative AI model, generating new output involves providing an input to the trained model in the form of a point or distribution in the latent space. During training, the encoder network learned to compress input data into this latent space, while the decoder learned to map points from the latent space back into meaningful data. To generate new data, the system may sample a point from the latent space, typically by sampling from a predefined distribution (e.g., a Gaussian distribution), or a user may provide specific coordinates within the latent space to control the nature of the output. The decoder network then transforms this latent vector into a new data instance (e.g., an image or piece of text) that conforms to the patterns learned during training. Since the latent space has been structured to capture the key features of the input data, small variations in the latent space coordinates may result in new data with slight variations, allowing the system to produce diverse but coherent outputs.

In embodiments where the generative AI model has been trained using a GAN, the process for generating new output also involves providing an input in the form of a random noise vector sampled from the latent space. Unlike VAEs, where the latent space is learned explicitly during training, GANs use this latent space as a starting point for the generator to produce new data. The trained generator network takes the random input vector and transforms it into a new data sample, such as an image, based on the patterns it has learned during training. The determinator is no longer needed in this phase, as its role was limited to training. Once the generator has been trained to produce realistic outputs, it can generate new data by mapping random noise vectors to complex data points that resemble the original dataset. For example, in a GAN trained on images of landscapes, providing a random vector in the latent space will result in the generation of a new, never-before-seen landscape that adheres to the patterns the generator learned during training. The latent space in GANs encodes abstract features of the data, and small adjustments to the noise vector allow users to control specific aspects of the generated data, such as color, shape, or texture, enabling the generation of highly varied outputs.

It will be understood that the embodiment of the generative AI subsystem 200 illustrated in FIG. 2 is exemplary and that other embodiments may vary. The generative AI subsystem 200, as well as its constituent elements, may vary, and modifications or alternative configurations may be implemented without departing from the broader scope of the invention. For instance, different machine learning algorithms, data sources, optimization techniques, or training methodologies may be employed depending on system requirements, application domain, and available computational resources. Furthermore, features and functionalities described in one embodiment may be combined with those of another embodiment as needed, and vice versa.

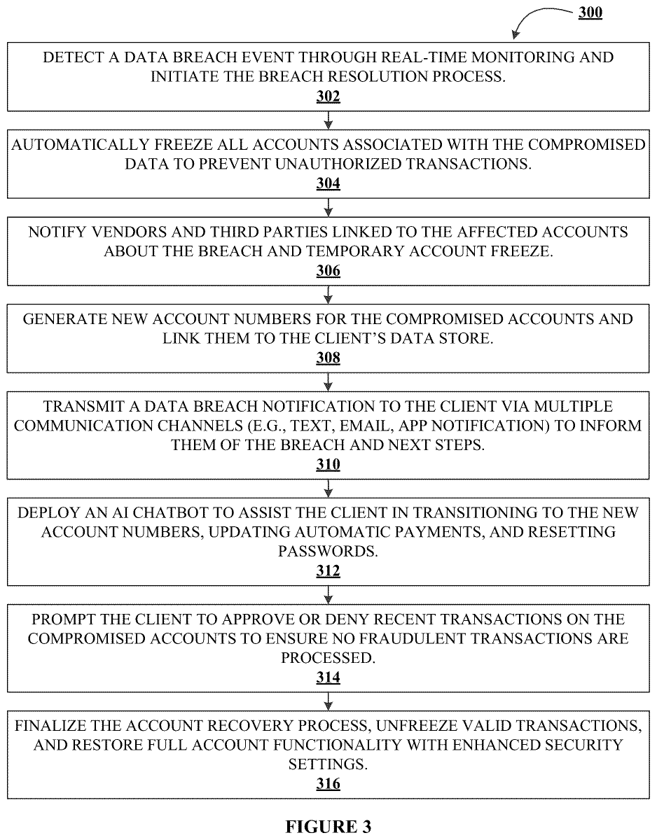

FIG. 3 illustrates a process flow for AI-driven data breach resolution, in accordance with an embodiment of the disclosure. This process utilizes a combination of artificial intelligence, machine learning, and automated actions to detect data breaches and secure client accounts immediately. As shown in block 302, the system continuously monitors data streams and account activity using real-time analytics and machine learning algorithms to identify potential data breaches. Embodiments of the invention may utilize machine learning models, such as anomaly detection models, trained on historical transaction data to detect irregular patterns that indicate a data breach. For instance, unsupervised learning techniques, such as clustering or outlier detection, may identify anomalous transactions or access patterns.

The system may be implemented using programming languages such as Python, R, or Java, in conjunction with machine learning frameworks like TensorFlow, PyTorch, or Scikit-learn. Real-time data processing may be achieved using Apache Kafka or Apache Flink, allowing continuous monitoring of data streams from various sources. These sources may include client transactions, login activity, and other relevant account interactions. To ensure rapid detection, the data ingestion and analysis components may operate on a server cluster or cloud infrastructure, such as Amazon Web Services (AWS), Microsoft Azure, or Google Cloud Platform. Hardware configurations for this process may include multi-core processors, high-speed storage systems (e.g., SSDs), and memory configurations that support large-scale data processing. Once a data breach event is detected, the system automatically initiates the breach resolution process, which triggers downstream actions as outlined below.

As shown in block 304, upon identifying a breach, the system immediately freezes all accounts linked to the compromised data to prevent further unauthorized transactions. In one embodiment, this freezing process is executed by issuing API calls to the account management systems or banking platforms to lock affected accounts. The freezing action may include disabling transactions, access to online portals, and any outgoing payments associated with the compromised accounts.

The freezing logic may be implemented using languages like JavaScript for web applications, Java or Python for server-side applications, and SQL for database-level account management. RESTful API protocols may be utilized to send requests to account management systems, while security protocols such as OAuth2 or JWT may be implemented to authenticate and secure these requests. In certain embodiments, the system may employ a microservices architecture to manage each account separately, ensuring that only compromised accounts are frozen without affecting other unrelated accounts. The freezing operation may be logged for auditing purposes, with timestamps and details stored in a secure database such as PostgreSQL, MongoDB, or Cassandra. Additionally, the system may utilize role-based access control (RBAC) to limit account freezing permissions to authorized components, enhancing the security and reliability of the process.

As shown in block 306, once the accounts are frozen, the system automatically notifies any vendors or third parties linked to the affected accounts, informing them of the breach and temporary account freeze. These notifications may be issued via secure API calls, email, or SMS, depending on the vendor's communication preferences and security requirements. In one embodiment, the notification process is implemented using a message queue system, such as RabbitMQ or Amazon SQS, to handle the high volume of notifications that may need to be sent simultaneously to multiple vendors. This asynchronous processing ensures that each vendor receives the notification without creating delays in the system's overall operation.

The notification messages may include details about the account freeze, the reason for the action, and instructions for resuming transactions once the breach is resolved. The messages are generated dynamically and customized for each vendor using templates in HTML or JSON format, which may be filled with relevant data points by a templating engine such as Jinja2 (for Python) or Handlebars.js (for JavaScript). The system may also record a log of each notification, including the timestamp, recipient details, and status (e.g., sent, delivered, or failed), in a secure, immutable ledger or database for compliance and auditing purposes.

AS shown in block 308, following vendor notification, the system generates new account numbers to replace the compromised ones, ensuring that the client's data store remains secure. In one embodiment, this step is implemented through secure random number generation algorithms to create unique account numbers. These account numbers are then linked to the client's existing data store within the system.

The generation and linking process may use cryptographic libraries, such as OpenSSL for C++ or the PyCryptodome library for Python, to ensure that account numbers are generated securely and are resistant to prediction or duplication. The system may employ hashing functions, such as SHA-256, to securely store and manage these account numbers.

Once generated, each new account number is stored in a secure database, such as MySQL or DynamoDB, and associated with the client's data store using unique identifiers. The database itself may be encrypted using standards like AES-256 encryption to protect against unauthorized access. The linking process may involve updating pointers or foreign key references in the client's data store table to reflect the newly assigned account numbers.

In some embodiments, additional security checks, such as multi-factor authentication, may be required before activating the new account numbers. This ensures that only the verified client or authorized users can access the updated accounts. These security protocols may be implemented using libraries such as Google Authenticator APIs or Duo Security APIs for multi-factor authentication.

As shown in block 310, the system transmits a data breach notification to the client, informing them of the breach and providing guidance on next steps. This notification is sent through multiple channels to ensure that the client receives it promptly. These channels may include SMS text messaging, email, push notifications on mobile devices, and in-app notifications for clients who use the provider's mobile or web applications. The notification transmission process may be implemented using various communication APIs and libraries. For instance, the system may leverage Twilio for SMS notifications, SendGrid or Amazon SES for email notifications, and Firebase Cloud Messaging for push notifications. The message content is dynamically generated, containing personalized details specific to the client's account and instructions on how to proceed.

In one embodiment, the message templates are stored in a templating engine, such as Jinja2 for Python or Thymeleaf for Java, enabling dynamic generation of personalized messages. Each message may contain a summary of the detected breach, steps that have been taken to secure the account, and guidance on actions the client needs to perform. Additionally, the system may maintain a log of all sent notifications, including the timestamp, delivery status, and client response (if applicable). This log may be stored in a secure database, such as MongoDB or MySQL, to comply with regulatory requirements and provide an audit trail of all client communications.

As shown in block 312, after notifying the client of the breach, the system deploys an AI-driven chatbot to assist the client through the transition process. The chatbot is designed to provide step-by-step guidance for updating account numbers, redirecting autopay instructions to the new accounts, changing passwords, and other necessary actions. This interactive chatbot aims to reduce the complexity of account recovery for the client by automating common tasks and answering frequently asked questions.

The chatbot functionality may be implemented using AI platforms like Dialogflow, IBM Watson Assistant, or Rasa, which allow for natural language processing and conversational flow management. In one embodiment, the chatbot is integrated into the provider's mobile or web applications, enabling real-time interaction with clients. The chatbot may also be available on messaging platforms, such as WhatsApp or Facebook Messenger, using APIs that connect it to these services. The chatbot's responses are dynamically generated based on the client's inputs and account status. For example, if the client asks for help updating autopay information, the chatbot can guide them through the necessary steps and provide links to set up autopay on the new account. The chatbot may also authenticate clients using multi-factor authentication methods, such as OTPs sent via SMS or email, before performing sensitive actions like password resets.

For security and efficiency, all interactions with the chatbot may be encrypted using TLS (Transport Layer Security), ensuring that client information remains protected. The chatbot's interactions are logged and stored securely, allowing for analysis of common client issues and further improvements to the chatbot's response accuracy and support scope.

As shown in block 314, following the setup of the new account numbers, the system prompts the client to review recent transactions on the compromised accounts. This step enables the client to approve or deny each transaction to prevent any malfeasant resource requests from being processed. The approval/denial process is designed to be simple and accessible, with an intuitive interface, such as an “Approve” or “Deny” button, for each transaction. This functionality may be implemented using a secure web interface or mobile app interface developed with front-end frameworks like React or Angular, and back-end services like Node.js or Django. The list of recent transactions is retrieved from the account database and presented to the client, allowing them to make decisions on each transaction.

For added security, the system may prompt the client to confirm their identity using multi-factor authentication before accessing the transaction review interface. Once the client has reviewed and approved or denied each transaction, the system updates the transaction records accordingly. Approved transactions may be reprocessed, while denied transactions are flagged for further investigation or adjudication. All actions taken by the client during the review process are logged, including timestamps, transaction IDs, and approval/denial decisions. This log may be stored in a secure, tamper-proof database for compliance and record-keeping purposes, such as an encrypted SQL or NoSQL database.

In the final step, as shown in block 316, the system completes the account recovery process by unfreezing any valid, approved transactions and restoring full account functionality with enhanced security settings. This step involves re-enabling access to the client's accounts, ensuring that the client can resume regular transactions while benefiting from heightened security protections. The account unfreezing process is carried out by issuing API requests to the account management system, which may be built on Java or Python back-end services. The system performs a final check to confirm that all necessary recovery actions have been completed, such as updating account numbers, redirecting autopay instructions, and securing passwords.

Enhanced security settings may include enabling two-factor authentication, enforcing stronger password policies, or implementing account activity alerts. These security settings are configured automatically and may be customized based on the client's preferences. For example, clients may be prompted to set up multi-factor authentication using Google Authenticator, Duo Security, or SMS-based verification. Once the recovery process is complete, a final notification may be sent to the client to inform them that their account is fully restored and secure. This notification may be delivered via the client's preferred communication channel, such as email or SMS. The entire account recovery and transaction unfreezing process is logged in an audit trail, stored in a secure database for regulatory compliance and future reference.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for AI-driven data breach resolution, the system comprising:
a processing device;
a non-transitory storage device containing instructions when executed by the processing device, causes the processing device to perform the steps of:
detecting a data breach event in real-time by analyzing account activity and identifying anomalies associated with unauthorized access;
freezing one or more accounts associated with the unauthorized access to prevent unauthorized transactions;
notifying one or more vendors associated with frozen accounts about the data breach event and account freeze;
generating new account numbers for the one or more accounts and linking the new account numbers to a client data store;
transmitting a data breach notification to a client through multiple communication channels, including text, email, and app notifications, to inform the client of the data breach and provide guidance on recovery steps;
deploying an AI-driven chatbot to assist the client with transitioning to the new account numbers, updating automatic payments, and resetting account credentials; and
prompting the client to approve or deny recent transactions on the compromised accounts to ensure that malfeasant transactions are blocked and legitimate transactions proceed.

2. The system of claim 1, wherein executing the instructions further causes the processing device to: log each step of a data breach resolution process, including timestamps, transaction details, and client interactions, in a secure, non-volatile storage medium for audit and compliance purposes.

3. The system of claim 1, wherein the AI-driven chatbot is configured to authenticate the client using multi-factor authentication prior to initiating any changes to account credentials or payment settings.

4. The system of claim 1, wherein the data breach notification transmitted to the client includes a unique code or secure link that, when accessed, enables the client to securely initiate an account recovery process.

5. The system of claim 1, wherein executing the instructions further causes the processing device to perform real-time monitoring of account activity for a predetermined period following the resolution of the data breach, to detect any recurring anomalies or unauthorized access attempts.

6. The system of claim 1, wherein the new account numbers generated for the client data store are encrypted and stored in a secure database with access limited to authorized system components.

7. The system of claim 1, wherein the processing device is configured to dynamically adjust the communication channel for client notifications based on historical preferences or recent interaction patterns of the client.

8. A computer program product for AI-driven data breach resolution, the computer program product comprising a non-transitory computer-readable medium comprising code causing an apparatus to:
detecting a data breach event in real-time by analyzing account activity and identifying anomalies associated with unauthorized access;
freezing one or more accounts associated with the unauthorized access to prevent unauthorized transactions;
notifying one or more vendors associated with frozen accounts about the data breach event and account freeze;
generating new account numbers for the one or more accounts and linking the new account numbers to a client data store;
transmitting a data breach notification to a client through multiple communication channels, including text, email, and app notifications, to inform the client of the data breach and provide guidance on recovery steps;
deploying an AI-driven chatbot to assist the client with transitioning to the new account numbers, updating automatic payments, and resetting account credentials; and
prompting the client to approve or deny recent transactions on the compromised accounts to ensure that malfeasant transactions are blocked and legitimate transactions proceed.

9. The computer program product of claim 8, wherein the code further causes the apparatus to: log each step of a data breach resolution process, including timestamps, transaction details, and client interactions, in a secure, non-volatile storage medium for audit and compliance purposes.

10. The computer program product of claim 8, wherein the AI-driven chatbot is configured to authenticate the client using multi-factor authentication prior to initiating any changes to account credentials or payment settings.

11. The computer program product of claim 8, wherein the data breach notification transmitted to the client includes a unique code or secure link that, when accessed, enables the client to securely initiate an account recovery process.

12. The computer program product of claim 8, wherein executing the instructions further causes the processing device to perform real-time monitoring of account activity for a predetermined period following the resolution of the data breach, to detect any recurring anomalies or unauthorized access attempts.

13. The computer program product of claim 8, wherein the new account numbers generated for the client data store are encrypted and stored in a secure database with access limited to authorized system components.

14. The computer program product of claim 8, wherein the code further causes the apparatus to: dynamically adjust the communication channel for client notifications based on historical preferences or recent interaction patterns of the client.

15. A method for AI-driven data breach resolution, the method comprising:
detecting a data breach event in real-time by analyzing account activity and identifying anomalies associated with unauthorized access;
freezing one or more accounts associated with the unauthorized access to prevent unauthorized transactions;
notifying one or more vendors associated with frozen accounts about the data breach event and account freeze;
generating new account numbers for the one or more accounts and linking the new account numbers to a client data store;
transmitting a data breach notification to a client through multiple communication channels, including text, email, and app notifications, to inform the client of the data breach and provide guidance on recovery steps;
deploying an AI-driven chatbot to assist the client with transitioning to the new account numbers, updating automatic payments, and resetting account credentials; and
prompting the client to approve or deny recent transactions on the compromised accounts to ensure that malfeasant transactions are blocked and legitimate transactions proceed.

16. The method of claim 15, wherein the method further comprises: log each step of a data breach resolution process, including timestamps, transaction details, and client interactions, in a secure, non-volatile storage medium for audit and compliance purposes.

17. The method of claim 15, wherein the AI-driven chatbot is configured to authenticate the client using multi-factor authentication prior to initiating any changes to account credentials or payment settings.

18. The method of claim 15, wherein the data breach notification transmitted to the client includes a unique code or secure link that, when accessed, enables the client to securely initiate an account recovery process.

19. The method of claim 15, wherein executing the instructions further causes the processing device to perform real-time monitoring of account activity for a predetermined period following the resolution of the data breach, to detect any recurring anomalies or unauthorized access attempts.

20. The method of claim 15, wherein the new account numbers generated for the client data store are encrypted and stored in a secure database with access limited to authorized system components.
